(19) United States
(12) Patent Application Publication
(10) Pub. No.: US 2024/0203638 A1
(43) Pub. Date: Jun. 20, 2024

(54) INDUCTOR DEVICE

(71) Applicant: Realtek Semiconductor Corporation, Hsinchu (TW)

(72) Inventor: Cheng-Wei LUO, Hsinchu (TW)

(21) Appl. No.: 18/366,634

(22) Filed: Aug. 7, 2023

(30) Foreign Application Priority Data
Dec. 15, 2022 (TW) 111148335

(51) Int. Cl. H01F 27/29; H01F 17/00; H01F 27/28

(52) U.S. Cl. CPC H01F 27/29; H01F 17/0006; H01F 27/2823; H01F 2017/0073

(57) ABSTRACT

An inductor device includes a first wire, a second wire, and a connector. The first wire includes a first terminal and a second terminal. The first terminal of the first wire is disposed on a first side of the inductor device. The second terminal of the first wire is disposed on a second side of the inductor device. The second wire includes a first terminal and a second terminal. The first terminal of the second wire is disposed on the first side of the inductor device. The second terminal of the second wire is disposed on the second side of the inductor device. The connector couples the second terminal of the first wire and the first terminal of the second wire. The first wire and the second wire are disposed to each other in a rotational symmetry manner on the basis of a center point of the inductor device.

### RELATED APPLICATIONS

This application claims priority to and the benefit of Taiwan Application Serial Number 111148335, filed on Dec. 15, 2022, the entire contents of which are incorporated herein by reference as if fully set forth below in its entirety and for all applicable purposes.

### BACKGROUND

### Field of Invention

The present disclosure relates to an electronic device. More particularly, the present disclosure relates to an inductor device.

### Description of Related Art

Various types of conventional inductors have their own advantages and disadvantages. For example, inductors with crossing structures have lower inductance density. Besides, stacking type inductors have a lower quality factors. As a result, the application ranges of the above-mentioned inductors are all limited.

In addition, no matter what type of the inductor is, the input/output terminals of the inductor are hard to be disposed in a symmetrical manner, such that the performance of the inductor is affected. Besides, the inner wires of the inductor have higher parasitic capacitance, and the performance of the inductor is also affected. In view of the foregoing, problems and disadvantages are associated with existing products that require further improvement. However, those skilled in the art have yet to find a solution.

### SUMMARY

The foregoing presents a simplified summary of the disclosure in order to provide a basic understanding to the reader. This summary is not an extensive overview of the disclosure and it does not identify key/critical elements of the present disclosure or delineate the scope of the present disclosure. Its sole purpose is to present some concepts disclosed herein in a simplified form as a prelude to the more detailed description that is presented later.

One aspect of the present disclosure is to provide an inductor device. The inductor device comprises a first wire, a second wire, and a connection member. The first wire comprises a first terminal and a second terminal. The first terminal is disposed on a first side of the inductor device. The second terminal is disposed on a second side of the inductor device. The second wire comprises a first terminal and a second terminal. The first terminal is disposed on the first side of the inductor device. The second terminal is disposed on the second side of the inductor device. The connection member is coupled to the second terminal of the first wire and the first terminal of the second wire. The first wire and the second wire are disposed to each other in a rotational symmetry manner on a basis of a center point of the inductor device.

Another aspect of the present disclosure is to provide an inductor device. The inductor device comprises a first wire, a second wire, and a connection member. The first wire comprises a plurality of first sub-wires, a first terminal, and a second terminal. The plurality of first sub-wires are coupled to each other in an interlaced manner on an outer side of the inductor device. The first terminal is disposed on a first side of the inductor device. The second terminal is disposed on a second side of the inductor device. The second wire comprises a plurality of second sub-wires, a first terminal, and a second terminal. The plurality of second sub-wires are coupled to each other in an interlaced manner on the outer side of the inductor device. The first terminal is disposed on the first side of the inductor device. The second terminal is disposed on the second side of the inductor device. The connection member is coupled to the second terminal of the first wire and the first terminal of the second wire. The first wire and the second wire are disposed to each other in a rotational symmetry manner on a basis of a center point of the inductor device.

Therefore, based on the technical content of the present disclosure, the structure of the inductor device is extremely symmetrical so as to enhance the performance of the inductor device. In addition, the inductor device of the embodiment of the present disclosure has lower parasitic capacitance between the wires of the inductor device (i.e., voltage differences are the same), such that the performance of the inductor device enhances, for example, the quality factor of the inductor device enhances.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 depicts a schematic diagram of an inductor device according to one embodiment of the present disclosure;

FIG. 2 depicts a schematic diagram of an inductor device according to one embodiment of the present disclosure; and

FIG. 3 depicts a schematic diagram of experimental data of an inductor device according to one embodiment of the present disclosure.

According to the usual mode of operation, various features and elements in the figures have not been drawn to scale, which are drawn to the best way to present specific features and elements related to the disclosure. In addition, among the different figures, the same or similar element symbols refer to similar elements/components.

### DESCRIPTION OF THE EMBODIMENTS

To make the contents of the present disclosure more thorough and complete, the following illustrative description is given with regard to the implementation aspects and embodiments of the present disclosure, which is not intended to limit the scope of the present disclosure. The features of the embodiments and the steps of the method and their sequences that constitute and implement the embodiments are described. However, other embodiments may be used to achieve the same or equivalent functions and step sequences.

Unless otherwise defined herein, scientific and technical terminologies employed in the present disclosure shall have the meanings that are commonly understood and used by one of ordinary skill in the art. Unless otherwise required by context, it will be understood that singular terms shall include plural forms of the same and plural terms shall include the singular. Specifically, as used herein and in the claims, the singular forms “a” and “an” include the plural reference unless the context clearly indicates otherwise.

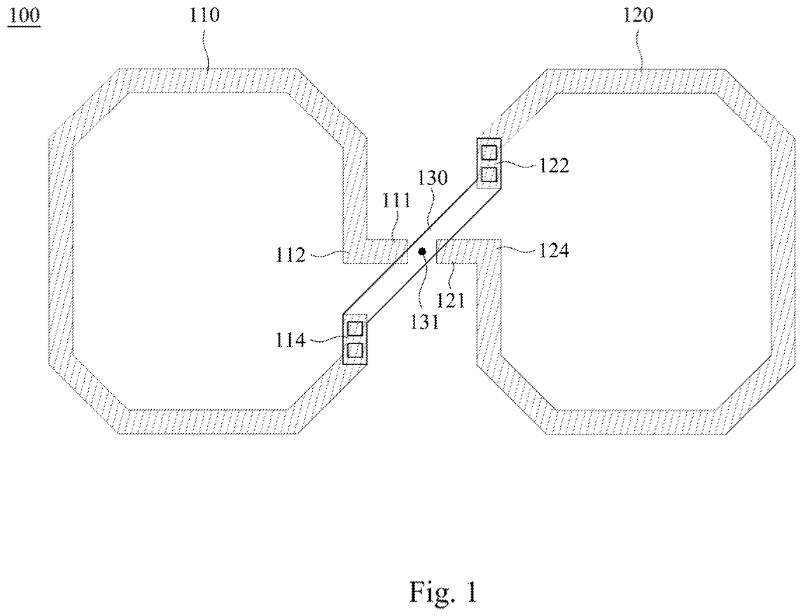

FIG. 1 depicts a schematic diagram of an inductor device 100 according to one embodiment of the present disclosure. As shown in the figure, the inductor device 100 includes a first wire 110, a second wire 120, and a connection member 130. The connection member 130 is configured to couple the first wire 110 and the second wire 120.

The first wire 110 includes a first terminal 112 and a second terminal 114. The first terminal 112 is disposed on the first side (e.g., the upper side) of the inductor device 100. The second terminal 114 is disposed on a second side (e.g., the lower side) of the inductor device 100. Besides, the second wire 120 includes a first terminal 122 and a second terminal 124. The first terminal 122 is disposed on the first side (e.g., the upper side) of the inductor device 100. The second terminal 124 is disposed on the second side (e.g., the lower side) of the inductor device 100. The connection member 130 is coupled to the second terminal 114 of the first wire 110 and the first terminal 122 of the second wire 120. In one embodiment, a left terminal of the connection member 130 is coupled to the second terminal 114 of the first wire 110 through the vias which are illustrated by squares, and a right terminal of the connection member 130 is coupled to the first terminal 122 of the second wire 120 through the vias which are illustrated by squares.

In addition, the first wire 110 and the second wire 120 are disposed to each other in a rotational symmetry manner on the basis of a center point of the inductor device 100. For example, the inductor device 100 can be rotated on the basis of the center point of the inductor device 100 as shown in the figure. After rotating for 180 degrees in a clockwise direction, the shape of the inductor device 100 will be the same as the shape of the inductor device 100 without rotating, which is called rotational symmetry. As a result, the structure of the inductor device 100 of the present disclosure is extremely symmetrical so as to enhance the performance of the inductor device 100.

In one embodiment, the inductor device 100 further includes a first input/output terminal 111. The first input/output terminal 111 is coupled to the first terminal 112 of the first wire 110. In another embodiment, the inductor device 100 further includes a second input/output terminal 121. The second input/output terminal 121 is coupled to the second terminal 124 of the second wire 120. In another embodiment, the first input/output terminal 111 of the inductor device 100 can be regard as a positive terminal, and the second input/output terminal 121 of the inductor device 100 can be regard as a negative terminal. As shown in the figure, the positive terminal is located at the left half of the inductor device 100, and the negative terminal is located at the right half of the inductor device 100. Therefore, the parasitic capacitance between the wires of the inductor device 100 is low (i.e., voltage differences are the same), such that the quality factor of the inductor device 100 enhances.

In another embodiment, the inductor device 100 further includes a center-tapped terminal 131. For example, a center point of the connection member 130 is used as the center-tapped terminal 131 of the inductor device 100. The center-tapped terminal 131 is disposed adjacent to the first input/output terminal 111 and the second input/output terminal 121. In one embodiment, the first input/output terminal 111 and the second input/output terminal 121 are disposed to each other in a symmetrical manner on the basis of the center point of the inductor device 100 as shown in the figure. Besides, the first input/output terminal 111 and the second input/output terminal 121 are disposed to each other face to face.

In one embodiment, the first terminal 112 and the second terminal 114 of the first wire 110 are disposed at a center location of the inductor device 100 (e.g., the center location of the figure, or an inner side of the inductor device 100). The first terminal 122 and the second terminal 124 of the second wire 120 are disposed at the center location of the inductor device 100.

In another embodiment, the first terminal 112 of the first wire 110 and the second terminal 124 of the second wire 120 are disposed to each other in a symmetrical manner on the basis of the center point, and the second terminal 114 of the first wire 110 and the first terminal 122 of the second wire 120 are disposed to each other in a symmetrical manner on the basis of the center point.

In one embodiment, the first wire 110 and the second wire 120 are located on a first layer of the inductor device 100, and the connection member 130 is located on a second layer of the inductor device 100. For example, the first layer is an Ultra Thick Metal (UTM) layer, and the second layer is a Redistribution Layer (RDL).

In another embodiment, the symmetrical type of the first wire 110 and the second wire 120 is a two-fold rotational symmetry. For example, if the first wire 110 and the second wire 120 are rotated for 360 degrees on the basis of the center point of the inductor device 100, the shape of the first wire 110 and the second wire 120 will be the same twice, which is called a two-fold rotational symmetry.

In one embodiment, the inductor device 100 of the present disclosure is suitable for a LC-tank voltage-controlled oscillator (VCO). It is noted that, the present disclosure is not limited to the structure as shown in FIG. 1, it is merely an example for illustrating one of the implements of the present disclosure, and the scope of the present disclosure shall be defined on the bases of the claims as shown below. In view of the foregoing, it is intended that the present disclosure covers modifications and variations to the embodiments of the present disclosure, and modifications and variations to the embodiments of the present disclosure also fall within the scope of the following claims and their equivalents.

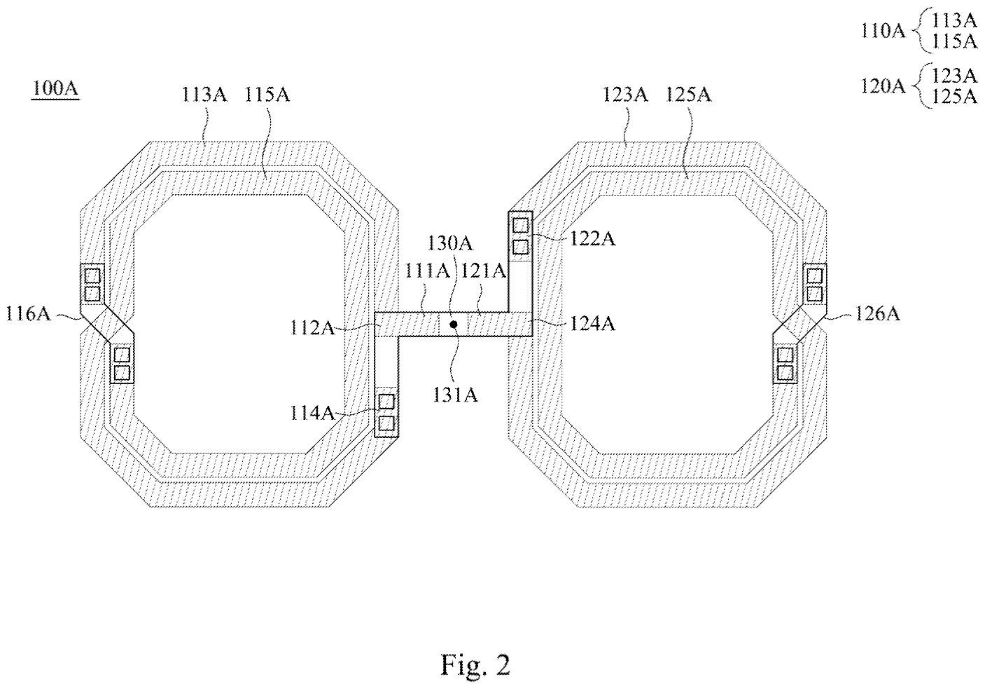

FIG. 2 depicts a schematic diagram of an inductor device 100A according to one embodiment of the present disclosure. It is noted that, compared with the inductor device 100 of FIG. 1, the first wire 110A of the inductor device 100A of FIG. 2 includes a plurality of first sub-wires 113A, 115A, the second wire 120A includes a plurality of second sub-wires 123A, 125A, and the shape of the connection member 130A is different, which will be described in detailed as shown below.

As mentioned above, the plurality of first sub-wires 113A, 115A of the first wire 110A of the inductor device 100A are coupled to each other in an interlaced manner on the outer side of the inductor device 100A. In one embodiment, the inductor device 100A further includes a first jumper 116A. The first jumper 116A can be used to couple to the plurality of first sub-wire 113A, 115A in an interlaced manner on the outer side of the inductor device 100A. For example, the first jumper 116A crosses the first sub-wire 115A of the plurality of first sub-wires 113A, 115A, and couples to the first sub-wire 113A of the plurality of first sub-wires 113A, 115A.

Besides, the plurality of second sub-wires 123A, 125A of the second wire 120A of the inductor device 100A are coupled to each other in an interlaced manner on the outer side of the inductor device 100A. In one embodiment, the inductor device 100A further includes a second jumper 126A. The second jumper 126A can be used to couple to the plurality of second sub-wires 123A, 125A in an interlaced manner on the outer side of the inductor device 100A. For example, the second jumper 126A crosses the second sub-wire 125A of the plurality of second sub-wires 123A, 125A, and couples to the second sub-wire 123A of the plurality of second sub-wires 123A, 125A. Because of the first wire 110A and the second wire 120A of the present disclosure all having multiple sub-wires (e.g., the first sub-wires 113A, 115A and the second sub-wires 123A, 125A), when the number of the sub-wires becomes larger, the parasitic capacitance of the inductor device 100A of the present disclosure becomes lower, such that the quality factor of the inductor device 100A becomes higher.

In one embodiment, the first input/output terminal 111A of the inductor device 100A can be regard as a positive terminal, and the second input/output terminal 121A of the inductor device 100A can be regard as a negative terminal. As shown in the figure, the positive terminal is located at the left half of the inductor device 100A, and the negative terminal is located at the right half of the inductor device 100A. Therefore, the parasitic capacitance between the wires of the inductor device 100A is low (i.e., voltage differences are the same), such that the quality factor of the inductor device 100A enhances.

In one embodiment, the shape of the connection member 130A is a Z shape. In another embodiment, the first wire 110A and the second wire 120A are located on a first layer of the inductor device 100A, and the connection member 130A, the first jumper 116A, and the second jumper 126A are located on a second layer of the inductor device 100A. For example, the first layer is a UTM layer, and the second layer is a RDL. It is noted that the element in FIG. 2, whose symbol is similar to the symbol of the element in FIG. 1, has similar structure feature in connection with the element in FIG. 1. Therefore, a detail description regarding the structure feature of the element in FIG. 2 is omitted herein for the sake of brevity. In addition, the present disclosure is not limited to the structure as shown in FIG. 2, and it is merely an example for illustrating one of the implements of the present disclosure.

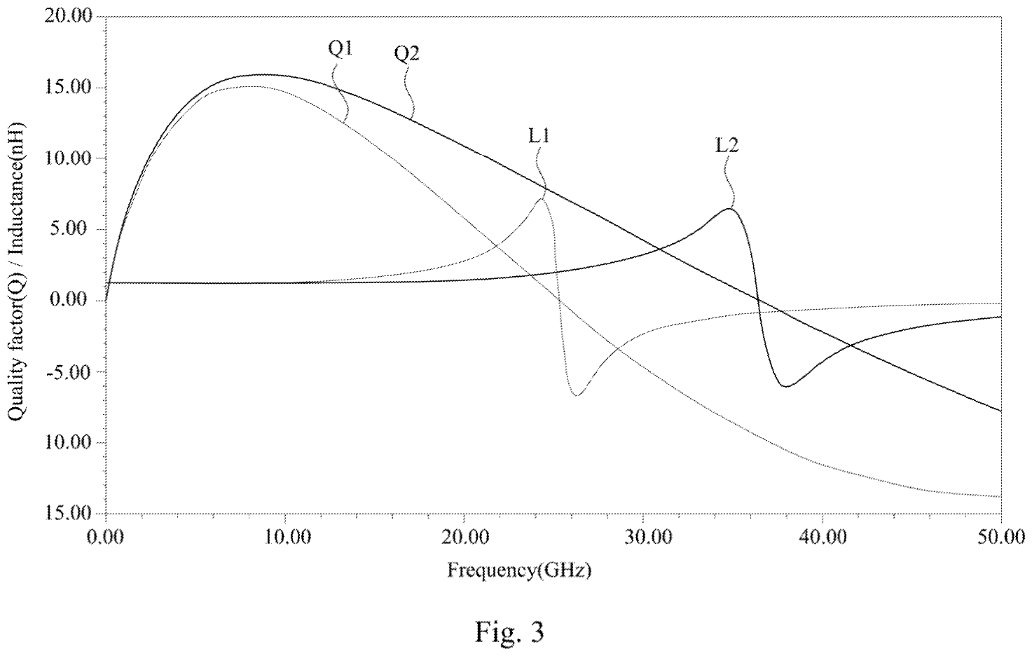

FIG. 3 depicts a schematic diagram of experimental data of the inductor devices 100, 100A according to some embodiments of the present disclosure. As shown in the figure, the curve Q1 is an experimental data of quality factor of a conventional inductor device. If the structural configuration of FIG. 1 or FIG. 2 according to the present disclosure is adopted, an experimental data of quality factor is the curve Q2. As can be seen from FIG. 3, the inductor device adopting the structure shown in FIG. 1 or FIG. 2 of the present disclosure has a better quality factor. In addition to that, the curve L1 shows an inductance value of a conventional inductor device, and its self-resonant frequency (Fsr) is about 24 GHz. Since the frequency where the self-resonant frequency occurs is closer to the peak of the quality factor of the curve Q1, it will have a greater impact on the quality factor. As for the inductance value represented by the curve L2 of the inductor device having the structure shown in FIG. 1 or FIG. 2 according to the present disclosure, its self-resonant frequency is about 35 GHZ. In comparing, since the frequency where the self-resonant frequency occurs is farther from the peak of the quality factor of the curve Q2, its effect on the quality factor is smaller.

It can be understood from the embodiments of the present disclosure that application of the present disclosure has the following advantages. The structure of the inductor device is extremely symmetrical so as to enhance the performance of the inductor device. In addition, the inductor device of the embodiment of the present disclosure has lower parasitic capacitance between the wires of the inductor device (i.e., the voltage differences between the wires are the same), such that the performance of the inductor device enhances, for example, the quality factor of the inductor device enhances.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An inductor device, comprising:
a first wire, comprising:
a first terminal, disposed on a first side of the inductor device; and
a second terminal, disposed on a second side of the inductor device;
a second wire, comprising:
a first terminal, disposed on the first side of the inductor device; and
a second terminal, disposed on the second side of the inductor device; and
a connection member, coupled to the second terminal of the first wire and the first terminal of the second wire, wherein the first wire and the second wire are disposed to each other in a rotational symmetry manner on a basis of a center point of the inductor device.

2. The inductor device of claim 1, further comprising:
a first input/output terminal, coupled to the first terminal of the first wire.

3. The inductor device of claim 2, further comprising:
a second input/output terminal, coupled to the second terminal of the second wire, wherein the first input/output terminal comprises a positive terminal, and the second input/output terminal comprises a negative terminal.

4. The inductor device of claim 3, further comprising:
a center-tapped terminal, disposed at the center point, and disposed adjacent to the first input/output terminal and the second input/output terminal.

5. The inductor device of claim 4, wherein the first input/output terminal and the second input/output terminal are disposed to each other in a symmetrical manner on a basis of the center point.

6. The inductor device of claim 5, wherein the first input/output terminal and the second input/output terminal are disposed to each other face to face.

7. The inductor device of claim 6, wherein the first terminal and the second terminal of the first wire are disposed at a center location of the inductor device, and the first terminal and the second terminal of the second wire are disposed at the center location of the inductor device.

8. The inductor device of claim 7, wherein the first terminal of the first wire and the second terminal of the second wire are disposed to each other in a symmetrical manner on a basis of the center point, and the second terminal of the first wire and the first terminal of the second wire are disposed to each other in a symmetrical manner on a basis of the center point.

9. The inductor device of claim 8, wherein the first wire and the second wire are located on a first layer of the inductor device, and the connection member is located on a second layer of the inductor device.

10. The inductor device of claim 9, wherein the first wire and the second wire are disposed to each other in a two-fold rotational symmetry manner.

11. An inductor device, comprising:
a first wire, comprising:
a plurality of first sub-wires, the plurality of first sub-wires being coupled to each other in an interlaced manner on an outer side of the inductor device;
a first terminal, disposed on a first side of the inductor device; and
a second terminal, disposed on a second side of the inductor device;
a second wire, comprising:
a plurality of second sub-wires, the plurality of second sub-wires being coupled to each other in an interlaced manner on the outer side of the inductor device;
a first terminal, disposed on the first side of the inductor device; and
a second terminal, disposed on the second side of the inductor device; and
a connection member, coupled to the second terminal of the first wire and the first terminal of the second wire, wherein the first wire and the second wire are disposed to each other in a rotational symmetry manner on a basis of a center point of the inductor device.

12. The inductor device of claim 11, further comprising:
a first input/output terminal, coupled to the first terminal of the first wire; and
a second input/output terminal, coupled to the second terminal of the second wire, wherein the first input/output terminal comprises a positive terminal, and the second input/output terminal comprises a negative terminal.

13. The inductor device of claim 12, further comprising:
a first jumper, crossing one of the plurality of first sub-wires, and coupled to another one of the plurality of first sub-wires; and
a second jumper, crossing one of the plurality of second sub-wires, and coupled to another one of the plurality of second sub-wires.

14. The inductor device of claim 13, further comprising:
a center-tapped terminal, disposed at the center point, and disposed adjacent to the first input/output terminal and the second input/output terminal.

15. The inductor device of claim 14, wherein the first input/output terminal and the second input/output terminal are disposed to each other in a symmetrical manner on a basis of the center point.

16. The inductor device of claim 15, wherein the first input/output terminal and the second input/output terminal are disposed to each other face to face.

17. The inductor device of claim 16, wherein the first terminal and the second terminal of the first wire are disposed on an inner side of the inductor device, and the first terminal and the second terminal of the second wire are disposed on the inner side of the inductor device.

18. The inductor device of claim 17, wherein the first terminal of the first wire and the second terminal of the second wire are disposed to each other in a symmetrical manner on a basis of the center point, and the second terminal of the first wire and the first terminal of the second wire are disposed to each other in a symmetrical manner on a basis of the center point.

19. The inductor device of claim 18, wherein the first wire and the second wire are located on a first layer of the inductor device, and the connection member, the first jumper, and the second jumper are located on a second layer of the inductor device.

20. The inductor device of claim 19, wherein the first wire and the second wire are disposed to each other in a two-fold rotational symmetry manner.
